(19) United States
(12) Patent Application Publication
(10) Pub. No.: US 2024/0253980 A1
(43) Pub. Date: Aug. 1, 2024

(54) SYSTEM AND METHOD FOR CONDUCTING HIGH-TEMPERATURE THERMOLYSIS OF WASTE MIXTURE

(71) Applicant: IFALLIANCEUSA LLC, New York, NY (US)

(72) Inventor: Farhad MAMMADOV, BRICK, NJ (US)

(21) Appl. No.: 18/116,391

(22) Filed: Mar. 2, 2023

Related U.S. Application Data
(63) Continuation-in-part of application No. 18/103,693, filed on Jan. 31, 2023.

(51) Int. Cl. C01B 3/02; B01J 6/00; C01B 3/50; C01B 3/56; C02F 11/10; C10B 53/02; C10B 57/10; C10B 57/16; C10J 3/72; C10J 3/84; F02C 3/20

(52) U.S. Cl. CPC C01B 3/02; B01J 6/008; C01B 3/506; C01B 3/56; C02F 11/10; C10B 47/18; C10B 53/02; C10B 57/10; C10B 57/16; C10J 3/721; C10J 3/84; F02C 3/20; C01B 2203/042; C01B 2203/046; C01B 2203/84; C10J 2300/092; C10J 2300/0946; C10J 2300/1671; C10J 2300/1693

(57) ABSTRACT

A system and method for conducting high-temperature thermolysis of a waste mixture formed by sewage sludge and wood waste (e.g., creosote-impregnated wooden railway sleepers and utility poles) are proposed. The products of the high-temperature thermolysis may be used to produce thermal energy, electrical energy, carbon black, and liquid fractions which may be used profitably for various purposes.

### TECHNICAL FIELD

The present disclosure relates generally to the field of thermal destruction of solid industrial wastes. In particular, the present disclosure relates to a system and method for conducting high-temperature thermolysis of a waste mixture (e.g., formed by fragments of sewage sludge, creosote-impregnated wooden railway sleepers and utility poles, etc.) to produce thermal energy, electrical energy, hard carbon, and gas-liquid fractions.

### BACKGROUND

The growth of the urban population and the development of industry are accompanied by an increase in the volume of wastewater and their sewage sludge. In industrialized countries, each inhabitant generates, on average, 19-25 kg of dry sewage sludge per year, which leads to the accumulation of a large amount of sewage sludge. The sewage sludge belongs to an industrial waste to be recycled. The problem of recycling the sewage sludge is relevant, and a selected recycling scheme should provide high-quality recycling aimed at producing thermal energy, electrical energy, carbon black and liquid fractions which are subject to further beneficial use.

End-of-life creosote-impregnated wooden railway sleepers and utility poles are industrial wastes that must be recycled to produce fuel. In the construction of railway tracks, wooden sleepers were used in the past, which had to be protected from rapid decay. For this purpose, a special antiseptic, mainly creosote, was used. This substance is very toxic, and, therefore, the storage of the end-of-life wooden sleepers and utility poles is the reason for a large concentration of toxins and poisonous gases in the place of their storage. Creosote (coal creosote oil) is a product of the distillation of coal tar at a temperature of 200 to 400° ° C. It is a dark brown liquid (having a specific gravity of 1.05 to 1.10 g/cm3 and a boiling point of 180 to) 200° C. with a pungent odor. Creosote contains 20.1% phenols, 17.2% phenanthrenes, 16.9% pyrenes, 22% acetone and 12% butanol. These compounds, once in the air, can cause severe poisoning in humans and the appearance of cancer diseases.

Thus, there is a need for a technical solution that enables recycling of the sewage sludge and the creosote-impregnated wooden railway sleepers and utility poles.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables recycling of sewage sludge and wooden waste (e.g., creosote-impregnated wooden railway sleepers and utility poles) by means of high-temperature thermolysis.

The objective above is achieved by the features of the independent claims in the appended claims. Further embodiments and examples are apparent from the dependent claims, the detailed description, and the accompanying drawings.

According to a first aspect, a system for conducting high-temperature thermolysis of a waste mixture is provided. The system comprises a sewage sludge storage configured to receive and store sewage sludge, and a wood waste storage configured to receive and store wood waste. The system further comprises a mixer configured to form the waste mixture by mixing the sewage sludge from the sewage sludge storage and the wood waste from the wood waste storage. The system further comprises a screw-conveyor dryer configured to heat and dehumidify the waste mixture, and a metering hopper arranged between the mixer and the screw-conveyor dryer. The metering hopper is configured to perform a metered supply of the waste mixture from the mixer to the screw-conveyor dryer while replacing ambient air with carbon dioxide (CO2). The system further comprises a carbon dioxide (CO2) source coupled to the metering hopper and configured to supply the carbon dioxide (CO2) to the metering hopper. The system further comprises a striker mill coupled to the screw-conveyor dryer. The striker mill is configured to obtain a pulverized mixture by conducting the high-temperature thermolysis of the waste mixture. The pulverized mixture comprises a solid fraction and a gas-vapor fraction. The solid fraction comprises coarse-grained hard carbon and fine-grained hard carbon. The system further comprises a first cyclonic separator coupled to the striker mill and configured to separate the coarse-grained hard carbon from the solid fraction of the pulverized mixture. The system further comprises a first storage configured to receive and store the coarse-grained hard carbon, and a first heat exchanger arranged between the first cyclonic separator and the first storage in order to cool and transport the coarse-grained hard carbon from the first cyclonic separator to the first storage. The system further comprises a second cyclonic separator coupled to the first cyclonic separator and configured to separate the fine-grained hard carbon from the solid fraction of the pulverized mixture. The system further comprises a second storage configured to receive and store the fine-grained hard carbon, and a second heat exchanger arranged between the second cyclonic separator and the second storage in order to cool and transport the fine-grained hard carbon from the second cyclonic separator to the second storage. The system further comprises a condenser coupled to the second cyclonic separator and configured to obtain a thermolysis liquid and a synthesis gas by cooling and condensing the gas-vapor fraction of the pulverized mixture. The system further comprises a thermolysis liquid storage coupled to the condenser and configured to receive and store the thermolysis liquid. The system further comprises a first synthesis gas storage coupled to the condenser and configured to receive and store the synthesis gas under overpressure of 1 bar, and a second synthesis gas storage configured to receive and store the synthesis gas under overpressure up to 10 bar. The system further comprises a gas compressor arranged between the first synthesis gas storage and the second synthesis gas storage. The gas compressor is configured to pump over the synthesis gas from the first synthesis gas storage to the second synthesis gas storage while increasing a pressure of the synthesis gas up to 10 bar. The system further comprises a fine filter coupled to the second synthesis gas storage and configured to clean the synthesis gas from mechanical impurities. The system further comprises a third synthesis gas storage coupled to the fine filter and configured to receive and store the purified synthesis gas under overpressure up to 10 bar, and an energy conversion unit coupled to the third synthesis gas storage and configured to convert a chemical energy stored in the purified synthesis gas into thermal and electrical energy. By using the system thus configured, any sewage sludge and any wood waste may be recycled jointly and efficiently to produce thermal energy, electrical energy, hard carbon, and gas-liquid fractions which may be used profitably for various purposes.

In one embodiment of the first aspect, the sewage sludge has a humidity of 8-12% and a fragment size of 5-7 mm. The sewage sludge prepared in this way ensures more efficient operation of the system. If the sewage sludge has a fragment size of less than 5 mm, this will lead to an excessive increase in energy costs spent on the mechanical grinding/processing of these fragments during the operation of the system. If the sewage sludge has a fragment size of more than 7 mm, this will lead to an increase in humidity by a value of more than 12% and entails an excessive increase in energy costs spent on bringing the sewage sludge fragments to a standard humidity of 8-12% (i.e., by removing excessive moisture therefrom). If the sewage sludge has a humidity of more than 12%, this will entail an increase in adhesion to the steel surfaces of the process equipment with which the sewage sludge comes into contact during the operation of the system, thereby significantly reducing the productivity of the whole thermolysis process.

In one embodiment of the first aspect, the wood waste has a humidity of 10-12% and a fragment size of 3-6 mm. The wood waste prepared in this way ensures more efficient operation of the system.

In one embodiment of the first aspect, the mixer is configured to form the waste mixture such that the sewage sludge and the wood waste are contained in the waste mixture in a proportion of 65 wt % by 35 wt %, respectively. The specified parameters of the waste mixture are optimal and have a positive effect on the operation of the system, as well as provide a higher quality of the resulting thermolysis products compared with the thermolysis products obtained by conducting the separate thermal destruction of the sewage sludge and the wood waste or by using other proportions of the sewage sludge and the wood waste.

In one embodiment of the first aspect, the metering hopper comprises a screw conveyor, an electric drive, a working chamber, a charging cone, an air outlet nozzle, a carbon dioxide inlet nozzle, and an electric sliding gate. The screw conveyor has a first end and a second end, and the electric drive is coupled to the first end of the screw conveyor to drive the screw conveyor. The working chamber is coupled to the second end of the screw conveyor and has an inner cavity. The charging cone is attached to the screw conveyor near the first end of the screw conveyor. The air outlet nozzle is attached to the working chamber. The carbon dioxide inlet nozzle is attached to the screw conveyor near the first end of the screw conveyor. The electric sliding gate is attached to the working chamber from below. The electric sliding gate is configured to cause the waste mixture to move from the inner cavity of the working chamber to the screw-conveyor dryer. By using the metering hopper thus configured, it is possible to deliver a desired (metered) amount of the waste mixture to the screw-conveyor dryer more efficiently.

In one embodiment of the first aspect, the screw-conveyor dryer is configured to dehumidify the waste mixture up to a humidity of 2-3% and heat the waste mixture up to a temperature of 350 to 400° C. The waste mixture thus dehumidified and heated may be further processed in the striker mill more efficiently, thereby providing better performance of the system.

In one embodiment of the first aspect, the screw-conveyor dryer comprises a hollow body, a top electric drive, a middle electric drive, a bottom electric drive, and a charging hopper. The hollow body comprises an inlet nozzle, a top coupling pipe, an outlet nozzle, a bottom tube, a bottom coupling pipe, a middle tube, and a top tube. Each of the bottom tube, the middle tube and the top tube has a screw conveyor arranged therein. The inlet nozzle is coupled to a system for supplying a gaseous heat-conducting medium to the hollow body. The outlet nozzle is coupled to a system for removing the gaseous heat-conducting medium from the hollow body. The top coupling pipe is configured to connect the top tube and the middle tube. The bottom coupling pipe is configured to connect the middle tube and the bottom tube. The middle tube is larger than the top tube in diameter but smaller than the bottom tube in diameter. The top electric drive is coupled to the screw conveyor in the top tube. The middle electric drive is coupled to the screw conveyor in the middle tube. The bottom electric drive is coupled to the screw conveyor in the bottom tube. The charging hopper is attached to the top tube and configured to receive the waste mixture from the metering hopper. By using the screw-conveyor dryer thus configured, it is possible to heat and dehumidify the waste mixture more efficiently.

In one embodiment of the first aspect, the striker mill is configured to conduct the high-temperature thermolysis of the waste mixture at a temperature of 720 to 760° C. By using these temperatures, the high-temperature thermolysis of the waste mixture may be conducted more efficiently, thereby resulting in products having high consumer properties (i.e., the resulting pulverized mixture may have better properties, such as a higher calorific value of the resulting synthesis gas, a more qualitative composition of the thermolysis liquid, etc.).

In one embodiment of the first aspect, the striker mill comprises a working chamber, a vertical drive shaft, an electric drive, and a horizontal spreading disk. The working chamber has a first cavity and a second cavity. The first cavity has a cylindrical part and a toroidal part. The cylindrical part has a bottom, and the cylindrical part and the toroidal part are interconnected near the bottom of the cylindrical part to form an annular slot having an upper section and a lower section. The cylindrical part has an inlet pipe coupled to the screw-conveyor dryer and an outlet pipe coupled to the first cyclonic separator. The second cavity surrounds the toroidal part of the first cavity and has at least one inlet nozzle for a heat-conducting medium and at least one outlet nozzle for the heat-conducting medium. The vertical drive shaft has a first end arranged outside the working chamber and a second end arranged inside the cylindrical part of the first cavity. The second end of the vertical drive shaft is attached to the horizontal spreading disk which in turn is aligned with the annular slot. The electric drive is coupled to the first end of the vertical drive shaft. The horizontal spreading disk is configured, due to a centrifugal force, to feed the waste mixture from the cylindrical part of the first cavity into the toroidal part of the first cavity through the upper section of the annular slot and then to remove the resulting pulverized mixture from the toroidal part of the first cavity through the lower section of the annular slot and the outlet pipe. By using the striker mill thus configured, it is possible to perform the high-temperature thermolysis (thermal destruction) of the waste mixture more efficiently.

In one embodiment of the first aspect, the first cyclonic separator is a uniflow cyclone. The uniflow cyclone may provide better separation of the coarse-grained hard black from the pulverized mixture.

In one embodiment of the first aspect, the second cyclonic separator is a group cyclone. The group cyclone may provide better separation of the fine-grained hard black from the solid fraction of the pulverized mixture.

According a second aspect, a method for conducting high-temperature thermolysis of a waste mixture is provided. The method starts with the step of forming the waste mixture by mixing sewage sludge and wood waste in a mixer. Then, the method goes on to the step of performing, by using a metering hopper, a metered supply of the waste mixture from the mixer to a screw-conveyor dryer while replacing ambient air with carbon dioxide (CO2). Next, the method proceeds to the step of heating and dehumidifying the waste mixture in the screw-conveyor dryer. After that, the method goes on to the step of obtaining a pulverized mixture by conducting the high-temperature thermolysis of the heated and dehumidified waste mixture in a striker mill. The pulverized mixture comprises a solid fraction and a gas-vapor fraction. The solid fraction comprises coarse-grained hard carbon and fine-grained hard carbon. The method further proceeds to the steps of separating, by using a first cyclonic separator, the coarse-grained hard carbon from the solid fraction of the pulverized mixture and transporting, by using a first heat exchanger, the separated coarse-grained hard carbon to a first storage. The method further proceeds to the steps of separating, by using a second cyclonic separator, the fine-grained hard carbon from the solid fraction of the pulverized mixture that has passed the first cyclonic separator and transporting, by using a second heat exchanger, the separated fine-grained hard carbon to a second storage. The method further goes on to the steps of obtaining, by using a condenser, a thermolysis liquid and a synthesis gas by cooling and condensing the gas-vapor fraction of the pulverized mixture that has passed through the first cyclonic separator and the second cyclonic separator, and storing the separated thermolysis liquid in a thermolysis liquid storage and the separated synthesis gas in a first synthesis gas storage under overpressure of 1 bar. The method further proceeds to the steps of pumping over, by using a gas compressor, the synthesis gas from the first synthesis gas storage to a second synthesis gas storage while increasing a pressure of the synthesis gas up to 10 bar and purifying, by using a fine filter, the pumped-over synthesis gas from the second synthesis gas storage from mechanical impurities. The method then proceeds to the step of storing the purified synthesis gas in a third synthesis gas storage under overpressure up to 10 bar. The method ends up with the step of converting, by using an energy conversion unit, a chemical energy of the purified synthesis gas from the third synthesis gas storage into thermal and electrical energy. By doing so, any sewage sludge and any wood waste may be recycled jointly and efficiently to produce thermal energy, electrical energy, hard carbon, and gas-liquid fractions which may be used profitably for various purposes.

In one embodiment of the second aspect, the sewage sludge has a humidity of 8-12% and a fragment size of 5-7 mm. The sewage sludge prepared in this way ensures more efficient execution of the method. If the sewage sludge has a fragment size of less than 5 mm, this will lead to an excessive increase in energy costs spent on the mechanical grinding/processing of these fragments during the method. If the sewage sludge has a fragment size of more than 7 mm, this will lead to an increase in humidity by a value of more than 12% and entails an excessive increase in energy costs spent on bringing the sewage sludge fragments to a standard humidity of 8-12% (i.e., by removing excessive moisture therefrom). If the sewage sludge has a humidity of more than 12%, this will entail an increase in adhesion to the steel surfaces of the process equipment with which the sewage sludge comes into contact during the method, thereby significantly reducing the productivity of the whole thermolysis process.

In one embodiment of the second aspect, the wood waste has a humidity of 10-12% and a fragment size of 3-6 mm. The wood waste prepared in this way ensures more efficient execution of the method.

In one embodiment of the second aspect, the waste mixture is formed in the mixer such that the sewage sludge and the wood waste are contained in the waste mixture in a proportion of 65 wt % by 35 wt %, respectively. The specified parameters of the waste mixture are optimal and have a positive effect on the execution of the method, as well as provide a higher quality of the resulting thermolysis products compared with the thermolysis products obtained by conducting the separate thermal destruction of the sewage sludge and the wood waste or by using other proportions of the sewage sludge and the wood waste.

In one embodiment of the second aspect, the waste mixture is dehumidified up to a humidity of 2-3% and heated up to a temperature of 350 to 400° C. in the screw-conveyor dryer. The waste mixture thus dehumidified and heated may be further processed in the striker mill more efficiently, thereby providing better execution of the method.

In one embodiment of the second aspect, the high-temperature thermolysis of the waste mixture is conducted in the striker mill at a temperature of 720 to 760° C. By using these temperatures, the high-temperature thermolysis of the waste mixture may be conducted more efficiently, thereby resulting in products having high consumer properties (i.e., the resulting pulverized mixture may have better properties, such as a higher calorific value of the resulting synthesis gas, a more qualitative composition of the thermolysis liquid, etc.).

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of a system for conducting high-temperature thermolysis of a waste mixture in accordance with one exemplary embodiment;

FIG. 2 shows a front view of a metering hopper included in the system of FIG. 1 in accordance with one exemplary embodiment;

FIG. 3 shows a front view of a screw-conveyor dryer included in the system of FIG. 1 in accordance with one exemplary embodiment;

FIG. 4 shows a sectional front view of a striker mill included in the system of FIG. 1 in accordance with one exemplary embodiment; and

FIGS. 5A and 5B show a flowchart of a method for operating the system of FIG. 1 in accordance with one exemplary embodiment.

### DETAILED DESCRIPTION

Various embodiments of the present disclosure are further described in more detail with reference to the accompanying drawings. However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the system and method disclosed herein may be implemented in practice by using any numbers of the embodiments provided herein. Furthermore, it should be understood that any embodiment of the present disclosure may be implemented using one or more of the features presented in the appended claims.

The word “exemplary” is used herein in the meaning of “used as an illustration”. Unless otherwise stated, any embodiment described herein as “exemplary” should not be construed as preferable or having an advantage over other embodiments.

Any positioning terminology, such as “left”, “right”, “top”, “bottom”, “above” “below”, “upper”, “lower”, “horizontal”, “vertical”, “front”, “rear”, etc., may be used herein for convenience to describe one element's or feature's relationship to one or more other elements or features in accordance with the figures. It should be apparent that the positioning terminology is intended to encompass different orientations of the apparatus disclosed herein, in addition to the orientation(s) depicted in the figures. As an example, if one imaginatively rotates the apparatus in the FIGS. 90 degrees clockwise, elements or features described as “left” and “right” relative to other elements or features would then be oriented, respectively, “above” and “below” the other elements or features. Therefore, the positioning terminology used herein should not be construed as any limitation of the invention.

Although the numerative terminology, such as “first”, “second”, etc., may be used herein to describe various embodiments, elements or features, these embodiments, elements or features should not be limited by this numerative terminology. This numerative terminology is used herein only to distinguish one embodiment, element or feature from another embodiment, element or feature. For example, a first synthesis gas storage may be called a second synthesis gas storage, and vice versa, without departing from the teachings of the present disclosure.

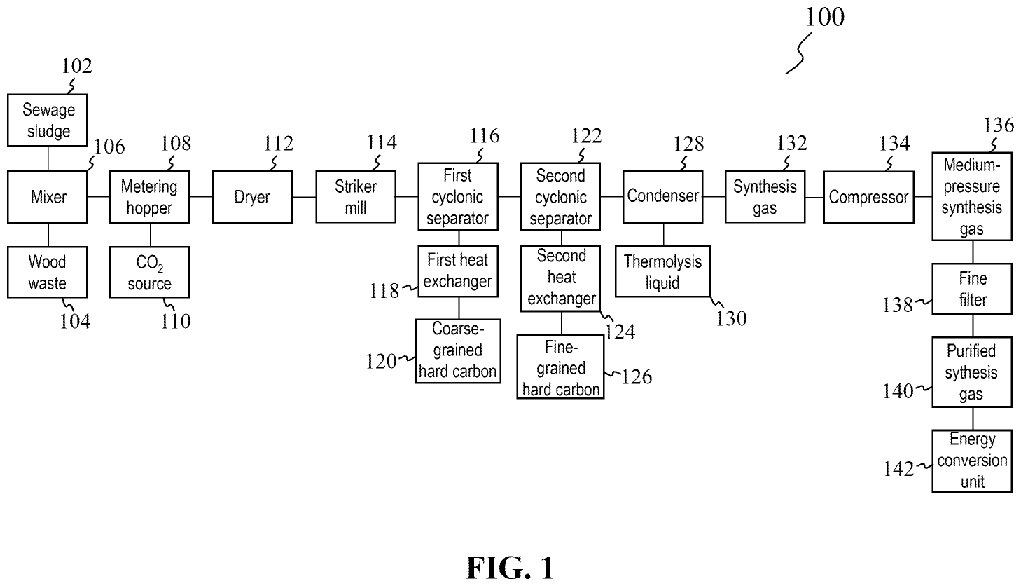

FIG. 1 shows a block diagram of a system 100 for conducting high-temperature thermolysis of a waste mixture in accordance with one exemplary embodiment. The system 100 comprises the following constructive elements: a sewage sludge storage 102, a wood waste storage 104, a mixer 106, a metering hopper 108, a carbon dioxide (CO2) source 110, a screw-conveyor dryer 112, a striker mill 114, a first cyclonic separator 116, a first heat exchanger 118, a first storage 120, a second cyclonic separator 122, a second heat exchanger 124, a second storage 126, a condenser 128, a thermolysis liquid storage 130, a first synthesis gas storage 132, a gas compressor 134, a second synthesis gas storage 136, a fine filter 138, a third synthesis gas storage 140, and an energy conversion unit 142. Each of the constructive elements of the system 100 will be described in detail below.

The sewage sludge storage 102 is configured to receive and store sewage sludge. In the exemplary embodiments disclosed herein, the sewage sludge may refer to the residual, semi-solid material that is produced as a by-product during sewage treatment of industrial or municipal wastewater. For example, the sewage sludge may be collected in sewage treatment plants. Preferably, before entering the sewage sludge storage 102, the sewage sludge is pre-treated to have a humidity of 8-12% and a fragment size of 5-7 mm. The sewage sludge storage 102 may be a production facility having technological equipment for receiving, storing, and accounting for the sewage sludge, as well as removing metals and other (unusual for the sewage sludge) substances from the sewage sludge. The sewage sludge storage 102 may be equipped with a moving floor, which may be required for the constant supply of the sewage sludge. A large volume of the sewage sludge is placed on the moving floor, the moving floor itself may serve as a kind of hopper, but its advantage over a conventional hopper is that it is quite easy to load the moving floor by unloading the sewage sludge from a vehicle body directly onto the moving floor.

The wood waste storage is configured to receive and store wood waste. The wood waste storage 104 may be a production facility having technological equipment for receiving, storing and accounting for the wood waste, as well as removing metals and other (unusual for the wood waste) substances from the wood waste. Preferably, before entering the wood waste storage 104, the wood waste is pre-treated to have a humidity of 10-12% and a fragment size of 3-6 mm.

The mixer 106 is configured to form the waste mixture by mixing the sewage sludge from the sewage sludge storage 102 and the wood waste from the wood waste storage 104. The mixer 106 may be a metal container having a cavity in which there are working bodies (e.g., stirrers) coupled to a drive (e.g., a gear-motor drive) and configured to provide mixing of the sewage sludge and the wood waste. The mixer 106 may also be equipped with conveyors for charging the sewage sludge and the wood waste, as well as with a screw conveyor for discharging the resulting waste mixture from the mixer 106 to the outside. Preferably, the waste mixture obtained by the mixer 106 contains 65 wt % of the sewage sludge and 35 wt % of the wood waste.

The metering hopper 108 is arranged between the mixer 106 and the screw-conveyor dryer 112. The metering hopper 108 is also coupled to the carbon dioxide (CO2) source 110. The main function of the metering hopper 108 is to perform a metered (or dosed) supply of the waste mixture from the mixer 106 to the screw-conveyor dryer 112 while replacing ambient air with carbon dioxide (CO2). Carbon dioxide is necessary to create an inert environment that excludes oxidative processes that occur using oxygen from the ambient air.

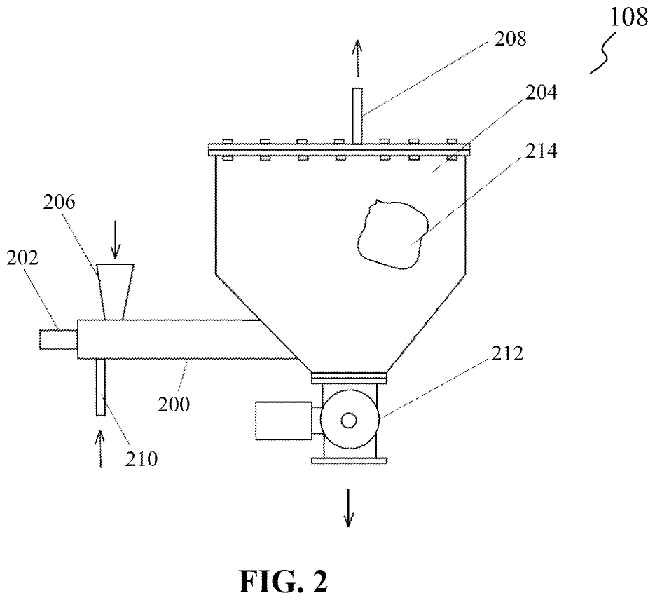

FIG. 2 shows a front view of the metering hopper 108 included in the system 100 in accordance with one exemplary embodiment. As shown in FIG. 2, the metering hopper 108 comprises a screw conveyor 200, an electric drive 202, a working chamber 204, a charging cone 206, an air outlet nozzle 208, a carbon dioxide inlet nozzle 210, and an electric sliding gate 212. The screw conveyor 200 has a first (left) end and a second (right) end, and the electric drive 202 (e.g., a gear-motor drive) is coupled to the first end of the screw conveyor 200 (i.e., to its working body) to drive the working body of the screw conveyor 200. The working chamber 204 is coupled to the second end of the screw conveyor 200 and has an inner cavity 214. The charging cone 206 is attached to the screw conveyor 200 near the first end of the screw conveyor 200 and communicates with the transport cavity of the screw conveyor 200. The air outlet nozzle 208 is attached to the working chamber 204 (i.e., to its upper section) and communicates with the inner cavity 214. The carbon dioxide inlet nozzle 210 is attached to the screw conveyor 200 near the first end of the screw conveyor 200 (i.e., under the charging cone 206) and communicates with the transport cavity of the screw conveyor 200. Thus, the screw conveyor 200 may provide the supply of the waste mixture from the mixer 106 and CO2 into the inner cavity 214 of the working chamber 204. The electric sliding gate 212 is attached to the working chamber 204 from below. The electric sliding gate 212 is configured to cause the waste mixture to move from the inner cavity 214 to the screw-conveyor dryer 112. The metering hopper 110 thus configured provides the metered or dosed supply of the waste mixture to the screw-conveyor dryer 112, as well as ensures the displacement of environmental air and its replacement with CO2 directly at the inlet to the screw-conveyor dryer 112.

The screw-conveyor dryer 112 is coupled to the metering hopper 108. The screw-conveyor dryer 112 is configured to heat and dehumidify the waste mixture coming from the metering hopper 110. Preferably, the screw-conveyor dryer 112 is configured to dehumidify the waste mixture up to a humidity of 2-3% and heat the waste mixture up to a temperature of 350 to 400° C.

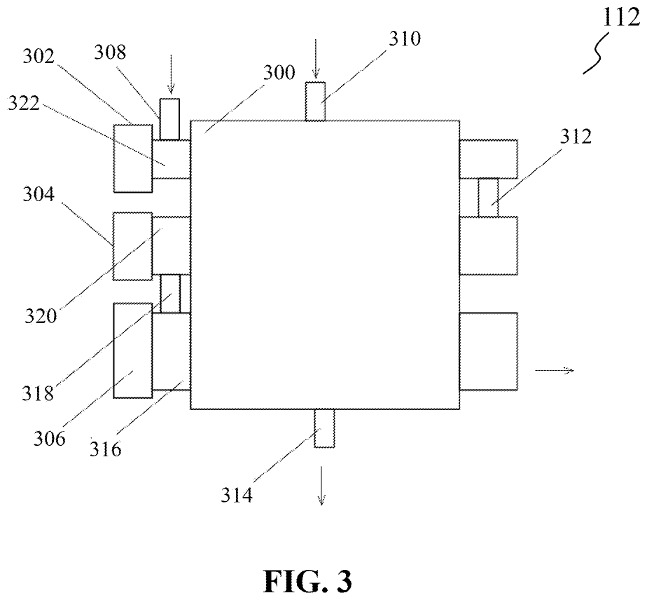

FIG. 3 shows a front view of the screw-conveyor dryer 112 included in the system 100 in accordance with one exemplary embodiment. The screw-conveyor dryer 112 comprises a hollow body 300, a top electric drive 302, a middle electric drive 304, a bottom electric drive 306, and a charging hopper 308. The hollow body 300 comprises an inlet nozzle 310, a top coupling pipe 312, an outlet nozzle 314, a bottom tube 316, a bottom coupling pipe 318, a middle tube 320, and a top tube 322. Each of the bottom tube 316, the middle tube 320 and the top tube 322 has a screw conveyor arranged therein. The top electric drive 302 is coupled to the screw conveyor (i.e., its working body) in the top tube 322. The middle electric drive 304 is coupled to the screw conveyor (i.e., its working body) in the middle tube 320. The bottom electric drive 306 is coupled to the screw conveyor (i.e., its working body) in the bottom tube 316. The charging hopper 308 is attached to the top tube 322 and configured to receive the waste mixture from the metering hopper 108. The inlet nozzle 310 is coupled to a system for supplying a gaseous heat-conducting medium to the cavity of the hollow body 300. The outlet nozzle 314 is coupled to a system for removing the gaseous heat-conducting medium from the cavity of the hollow body 300. The middle sections of the top tube 322, the middle tube 320 and the bottom tube 316 are arranged in the cavity of the hollow body 300 and are in contact with the gaseous heat-conducting medium, while the end sections of the top tube 322, the middle tube 320 and the bottom tube 316 are arranged outside the hollow body 300. The top coupling pipe 312 is configured to connect the top tube 322 and the middle tube 320. The bottom coupling pipe 318 is configured to connect the middle tube 320 and the bottom tube 316. The middle tube 320 is larger than the top tube 322 in diameter but smaller than the bottom tube 316 in diameter. From this circumstance, it follows that with equal productivity of these three sections, the revolutions of the screw conveyor arranged in the through cavity of the middle tube 320 are less than the revolutions of the screw conveyor arranged in the through cavity of the top tube 322, but greater than the revolutions of the screw conveyor arranged in the through cavity of the bottom tube 316. It is these ratios that have a positive effect on the time the transported waste mixture stays in heat transfer zones (this is required to ensure that the waste mixture is evenly heated to a desired temperature), as well as on the quality of the transported waste mixture transportation in terms of preventing the waste mixture from sticking to the contact surfaces.

During the operation of the screw-conveyor dryer 112, thermal energy from the gaseous heat-conducting medium is transferred to the middle sections of the top tube 322, the middle tube 320 and the bottom tube 316, and then to the transported waste mixture. The middle section of at least one of the top tube 322, the middle tube 320 and the bottom tube 316 may have holes to remove the excessive water vapor formed during drying. The heat-affected waste mixture from the screw-conveyor dryer 112 is removed from the through cavity of the bottom tube 316 by means of the screw conveyor arranged therein.

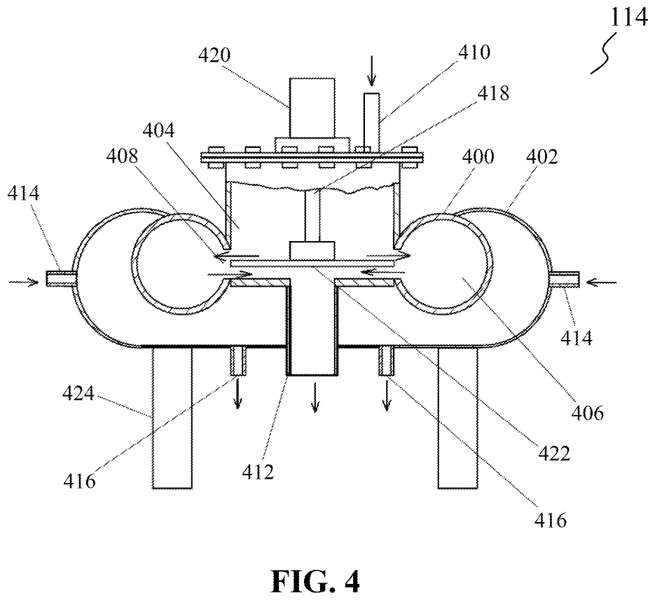

The striker mill 114 (also referred to as an impact mill in this technical filed) is coupled to the screw-conveyor dryer 112. The striker mill 114 is configured to conduct the high-temperature thermolysis of the waste mixture, grind the waste mixture, and remove the products of the thermolysis (i.e., a pulverized mixture comprising a solid fraction and a gas-vapor fraction) outside the striker mill 114. The striker mill 114 is a multifunctional object, and the implementation of its functions is carried out by means of a single electric drive (like the one denoted by 420 in FIG. 4).

FIG. 4 shows a sectional front view of the striker mill 114 included in the system 100 in accordance with one exemplary embodiment. The striker mill 114 comprises a working chamber comprising a first (inner) cavity 400 and a second (outer) cavity 402. The first cavity 400 has a cylindrical part 404 and a toroidal part 406 which are interconnected near the bottom of the cylindrical part 404 to form an annular slot 408. The cylindrical part 404 has an inlet pipe 410 coupled to the screw-conveyor dryer 112 and an outlet pipe 412 coupled to the first cyclonic separator 116. The second cavity 402 surrounds the toroidal part 406 of the first cavity 400 and has two inlet nozzles 414 for a (e.g., gaseous) heat-conducting medium and two outlet nozzles 416 for the heat-conducting medium. It should be noted that the present disclosure is not limited to the numbers of the inlet and outlet nozzles 414 and 416 which are shown in FIG. 4; in other embodiments, the second cavity 402 may have a single inlet nozzle and a single outlet nozzle for the heat-conducting medium, or more than two inlet nozzles and more than two outlet nozzles for the heat-conducting medium. The striker mill 114 further comprises a vertical drive shaft 418 having a first end arranged outside the working chamber and a second end arranged inside the cylindrical part 404 of the first cavity 400. The second end of the vertical drive shaft 418 is attached to a horizontal spreading disk 422 which is aligned with the annular slot 408. The striker mill 114 further comprises an electric drive 420 coupled to the first end of the vertical drive shaft 418. The working chamber may be supported by one or more vertical posts 424.

Through the inlet pipe 410, the waste mixture is fed from the screw-conveyor dryer 112 into the cylindrical part 404 of the first cavity 400 and then to the horizontal spreading disk 422. The waste mixture is fed into the toroidal part 406 of the first cavity 400 due to the centrifugal force exerting on the waste mixture arranged on the (upper) surface of the horizontal spreading disk 422, as well as due to the fact that the second end of the vertical drive shaft 418 is attached to the horizontal spreading disk 422 aligned with the annular slot 408. The horizontal spreading disk 422 is installed relative to the annular groove 408 such that the waste mixture is fed into the toroidal part 406 of the first cavity 400 to conduct the high-temperature thermolysis (or thermal destruction) exclusively through the upper section of the annular groove 408, and the products of the high-temperature thermolysis (i.e., the pulverized mixture) are removed from the toroidal part 406 of the first cavity 400 exclusively through the lower section of the annular groove 408 and the outlet pipe 412 (this is schematically shown by means of arrows in FIG. 4). The temperature required for the high-temperature thermolysis (preferably, in the range of 720 to 760° C.) is provided in the toroidal part 406 of the first cavity 400 by supplying the heat-conducting medium, through the inlet nozzles 414, into the second cavity 402. The heat-conducting medium is then removed from the second cavity 402 through the outlet nozzles 416.

The operational principle of the striker mill 114 is as follows.

The temperature required for the high-temperature thermolysis is provided and maintained in the second cavity 402 (including its wall) and in the toroidal part 406 (including its wall) of the first cavity 400 throughout the high-temperature thermolysis. After that, the electric drive 420 is turned on, thereby causing the vertical drive shaft 418 and, consequently, the spreading horizontal disc 422 to rotate. Then, the waste mixture is fed from the screw-conveyor dryer 112 into the cylindrical part 404 of the first cavity 400. Under the influence of the centrifugal force, the waste mixture arranged on the (upper) surface of the horizontal spreading disk 422 moves into the toroidal part 406 of the first cavity 400, hits the hot wall of the toroidal part 406, whereupon it heats up and mechanically breaks into numerous fragments, thereby leading to a significant increase in the area of the fragments of the waste mixture by 20-50 times. The concave shape of the wall of the toroidal part 406 provides numerous collisions of the fragments of the waste mixture against the wall of the toroidal part 406, as well as between themselves, which leads to their additional heating and grinding. The rotating horizontal spreading disk 422 supplies the waste mixture through the upper section of the annular slot 408 into the toroidal part 406 and subsequently removes the products of the high-temperature thermolysis from the toroidal part 406 of the first cavity 400 through the lower section of the annular slot 408 and the outlet pipe 412 (see the arrows in FIG. 4). As noted above, these products are represented by the pulverized mixture comprising the solid fraction and the gas-vapor fraction. The solid fraction may comprise coarse-grained hard carbon (e.g., with a grain size of 1.8 to 3.9 mm) and fine-grained hard carbon (e.g., with a grain size of 0.3 to 1.7 mm).

The first cyclonic separator 116 is coupled to the striker mill 114 and configured to separate the coarse-grained hard carbon from the pulverized mixture. The first cyclonic separator 116 may be further configured to cool the pulverized mixture to a temperature of 600-630° C. The first cyclonic separator 116 may be implemented as a uniflow cyclone that comprises a hollow steel body with a unit for supplying the pulverized mixture, a unit for swirling the supplied pulverized mixture, and a unit for separating a portion of the solid fraction from the pulverized mixture in the form of the coarse-grained hard carbon.

The first heat exchanger 118 is arranged between the first cyclonic separator 116 and the first storage 120. The first heat exchanger 118 is configured to cool and transport the coarse-grained hard carbon from the first cyclonic separator 116 to the first storage 120. During its transportation, the coarse-grained hard carbon is preferably cooled to a temperature of 50 to 60° C. For example, the first heat exchanger 118 may comprise an electric drive (e.g., a gear-motor drive), a hollow body with a cooling jacket, a screw conveyor with a cooling jacket, and a charging hopper. The working body of the screw conveyor is coupled to the electric drive. The cooling jackets of the hollow body and the screw conveyor are in contact with a coolant (e.g., water) which performs the function of removing thermal energy from the transported coarse-grained hard carbon.

The first storage 120 for the coarse-grained hard carbon may be implemented as a container having a side wall, a cavity, a unit for charging and discharging the coarse-grained hard carbon, a cone bottom with an electric sliding gate. The electric sliding gate ensures the extraction of the coarse-grained hard carbon from the cavity of the first storage 120.

The second cyclonic separator 122 is coupled to the first cyclonic separator 116 and configured to separate the fine-grained hard carbon from the solid fraction of the pulverized mixture. The second cyclonic separator 122 may be further configured to cool the pulverized mixture to a temperature of 520-560° C. The second cyclonic separator 122 may be implemented as a group cyclone, i.e., may comprise several cyclonic separators combine into a group. Each of the cyclonic separators included in the group may comprise a hollow steel body with a unit for supplying the pulverized mixture, a unit for swirling the supplied pulverized mixture, and a unit for separating a portion of the solid fraction of the pulverized mixture in the form of the fine-grained hard carbon.

The second heat exchanger 124 is arranged between the second cyclonic separator 122 and the second storage 126. The second heat exchanger 124 is configured to cool and transport the fine-grained hard carbon from the second cyclonic separator 122 to the second storage 126. During its transportation, the fine-grained hard carbon is preferably cooled to a temperature of 50 to 60° C. In general, the second heat exchanger 124 and the second storage 126 may be implemented in the same or similar manner as the first heat exchanger 116 and the first storage 120, respectively.

The condenser 128 is coupled to the second cyclonic separator 122 and configured to obtain a thermolysis liquid and a synthesis gas by cooling and condensing the gas-vapor fraction of the pulverized mixture. The condenser 128 may be a refrigerator-type condenser. In general, the condenser 128 may be a heat exchanger in which the following processes are performed: a condensation process, and a process of phase transition of a heat-conducting medium from a gas-vapor state to a liquid state due to heat removal by using a coolant. The superheated pulverized mixture is fed from the second cyclonic separator 122 into the condenser 128, then cooled to its saturation temperature (e.g., 20-50° C.) and, condensing, passes into a liquid phase with the formation of the thermolysis liquid and the synthesis gas. To condense steam, it is necessary to remove, from each unit of its mass, heat equal to a specific heat of condensation. The condenser 128 may be of water-cooled type.

The thermolysis liquid is then stored in the third storage 130 coupled to the condenser 128. The thermolysis liquid storage 130 may be also equipped with as a system for supplying and removing the thermolysis liquid. As for the synthesis gas, it goes to the first synthesis gas storage 132 where it is stored under overpressure of 1 bar. The first synthesis gas storage 132 is stationary and has a constant volume. The first synthesis gas storage 132 may comprise a wall forming the boundary of its inner cavity, a pump, and a gas burner with an emergency valve (emergency torch).

The gas compressor 134 is arranged between the first synthesis gas storage 132 and the second synthesis gas storage 136. The gas compressor 134 is configured to pump over the synthesis gas from the first synthesis gas storage 132 to the second synthesis gas storage 136 while increasing a pressure of the synthesis gas up to 10 bar. The second synthesis gas storage 136 may comprise a gas reducer necessary to stabilize the gas flow and reduce the pressure of the synthesis gas exiting under pressure from the cavity of the second synthesis gas storage 136.

The fine filter 138 is coupled to the second synthesis gas storage 136 and configured to purify the synthesis gas from mechanical impurities.

The third synthesis gas storage 140 is coupled to the fine filter 138 and configured to receive and store the purified synthesis gas under overpressure up to 10 bar.

The energy conversion unit 142 is coupled to the third synthesis gas storage 140 and configured to convert the chemical energy of the pressurized synthesis gas into thermal energy and electrical energy. The energy conversion unit 142 may be implemented as a gas-piston power plant comprising an internal combustion engine and a thermal energy extraction system; such a plant provides the conversion of the chemical energy of the burned synthesis gas into thermal and electrical energy. The dominant part of the thermal energy generated during the combustion of the synthesis gas is provided to a liquid that cools a piston group of the internal combustion engine, and is also removed, outside the internal combustion engine, with exhaust gases. To extract the thermal energy from the heated liquid, a heat exchanger is used, where the thermal energy is transferred from a liquid with a higher temperature to a liquid with a lower temperature. To extract the thermal energy from hot exhaust gases, a heat exchanger is also used, where thermal energy is transferred from hot exhaust gases to a heat-conducting liquid having a lower temperature. The chemical energy of the burned synthesis gas is also converted into electrical energy by means of a generator kinematically connected to a rotating shaft of the internal combustion engine.

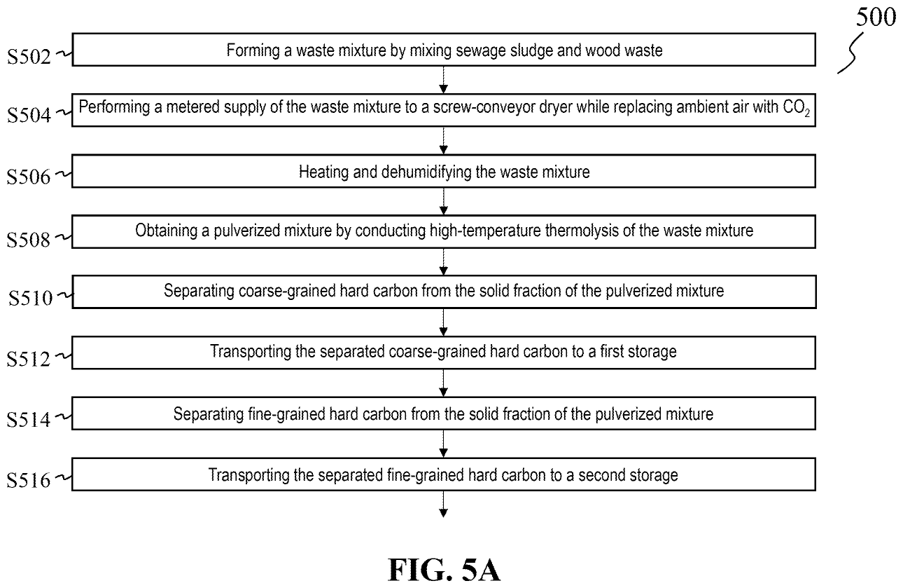

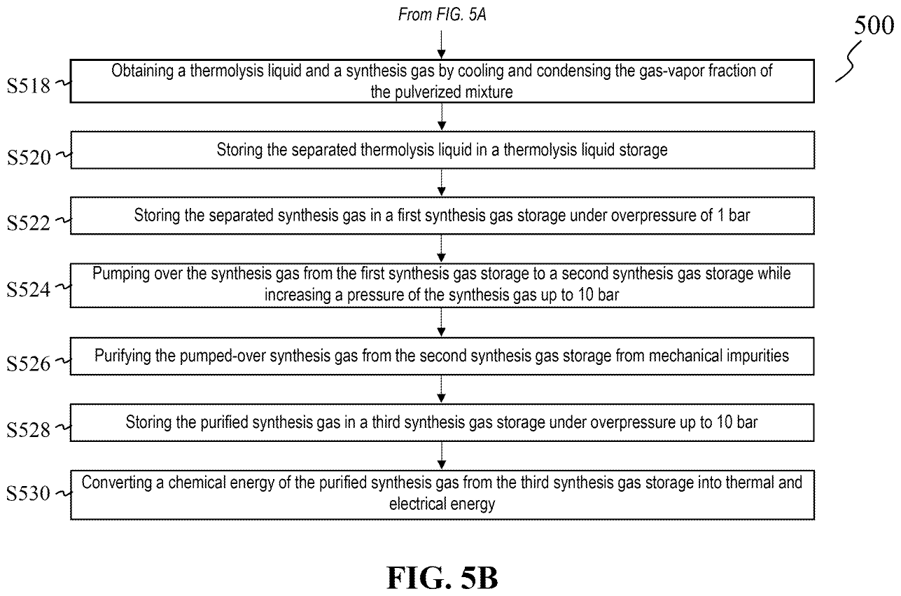

FIGS. 5A and 5B show a flowchart of a method 500 for operating the system 100 in accordance with one exemplary embodiment. The method 500 starts with a step S502, in which the mixer 106 forms the waste mixture by mixing the sewage sludge from the sewage sludge storage 102 and the wood waste from the wood waste storage 104. Preferably, the sewage sludge has a humidity of 8-12% and a fragment size of 5-7 mm, the wood waste has a humidity of 10-12% and a fragment size of 3-6 mm, and the mixing itself is performed such that the sewage sludge and the wood waste are contained in the resulting waste mixture in a proportion of 65 wt % by 35 wt %, respectively. Then, the method 500 goes on to a step S504, in which the metering hopper 108 performs a metered supply of the waste mixture from the mixer 106 to the screw-conveyor dryer 112 while replacing ambient air with carbon dioxide (CO2) from the carbon dioxide source 110. Next, the method 500 proceeds to a step S506, in which the waste mixture is dehumidified (e.g., to a humidity of 2-3%) and heated (e.g., up to a temperature of 350 to 400° C.) and heated (2-3% and heated up to a temperature of 350 to 400° C.) in the screw-conveyor dryer 112. After that, the method 500 goes on to a step S508, in which a pulverized mixture is obtained by conducting the high-temperature thermolysis of the heated and dehumidified waste mixture in the striker mill 114. Preferably, the high-temperature thermolysis is conducted at a temperature of 720 to 760° C. As noted above, the pulverized mixture comprises solid fraction and a gas-vapor fraction. The solid fraction comprises coarse-grained hard carbon and fine-grained hard carbon. The method 500 further proceeds to steps S510 and S512, in which the coarse-grained hard carbon is separated from the solid fraction of the pulverized mixture in the first cyclonic separator 116 and transported by using the first heat exchanger 118 to the first storage 120. The method 500 further proceeds to step S514, in which the pulverized mixture that has passed the first cyclonic separator 116 is processed in the second cyclonic separator 122 to separate the fine-grained hard carbon therefrom. In a next step S516, the fine-grained hard carbon is transported by using the second heat exchanger 124 to the second storage 126. The method 500 further goes on to step S518, in which a thermolysis liquid and a synthesis gas are obtained in the condenser 128 by cooling and condensing the gas-vapor fraction of the pulverized mixture that has passed through the first cyclonic separator 116 and the second cyclonic separator 122. The separated thermolysis liquid is stored in the thermolysis liquid storage 130 and the separated synthesis gas is stored in the first synthesis gas storage under overpressure of 1 bar in next steps S520 and S522, respectively. The method 500 further proceeds to a step S524, in which the synthesis gas is pumped over by the gas compressor 134 from the first synthesis gas storage 132 to the second synthesis gas storage 136 while increasing a pressure of the synthesis gas up to 10 bar. The pumped-over synthesis gas from the second synthesis gas storage 136 is further purified from mechanical impurities by using the fine filter 138 in a next step S526. The method 500 then proceeds to a step S528, in which the purified synthesis gas is stored in the third synthesis gas storage 140 under overpressure up to 10 bar. The method 500 ends up with a step S530, in which the chemical energy of the purified synthesis gas from the third synthesis gas storage 140 is converted by the energy conversion unit 142 (e.g., a gas-piston power plant) into thermal and electrical energy.

### Experiment

The constructive elements of the system 100 was arranged in the order shown in FIG. 1. Raw materials contained: the sewage sludge pre-cleaned (from mechanical impurities) and pre-treated to have a humidity of 8-12% and a fragment size of 5-7 mm, as well as creosote-impregnated fragments of wooden railway sleepers and utility poles pre-cleaned (from mechanical impurities) and pre-treated to have a humidity of 10-12% and a fragment size of 3-6 mm.

The experiment was carried out in accordance with the method 500 as follows.

1000 kg of a waste mixture was obtained, which comprises 65 wt % of the sewage sludge and 35 wt % of the wood waste. The waste mixture was dried to a humidity of 2-3% and heated to a temperature of 350-400° C. by using the screw-conveyor dryer 112 shown in FIG. 3. The waste mixture was fed into the screw-conveyor dryer 112 by using the metering hopper 108 shown in FIG. 2. The waste mixture was then subjected to mechanical shock grinding and high-temperature destruction in the striker mill 114 shown in FIG. 4 in a carbon dioxide environment at a temperature of 720-760° C. Coarse-grained hard carbon was separated from the resulting pulverized mixture by passing it through the first cyclonic separator 116 implemented as a uniflow cyclone, where the pulverized mixture was cooled to a temperature of 600-630° C. After that, the coarse-grained hard carbon was cooled to a temperature of 50 to 60° C. and transferred to the first storage 120 by means of the first heat exchanger 118. Next, fine-grained hard carbon was separated from the pulverized mixture by using the second cyclonic separator 122 implemented as a group cyclone, where the pulverized mixture was cooled to a temperature of 520-560° C. Further, the fine-grained hard carbon was cooled to a temperature of 50-60° C. and transferred to the second storage 126 by means of the second heat exchanger 124. Then, the remaining pulverized mixture was condensed by cooling it to a temperature of 20-50° C. in the condenser 128. The condensate was obtained in the form of a thermolysis liquid which was stored in the thermolysis liquid storage 130. The resulting synthesis gas was stored in the first synthesis gas storage 132 under overpressure of 1 bar. Then, by means of the gas compressor 134, the synthesis gas was supplied from the first synthesis gas storage 132 to the second synthesis gas storage 136, where it was stored under overpressure of 8-10 bar. After that, the synthesis gas was dried and purified by passing it through the fine filter 138, and subsequently stored in the third synthesis gas storage 140 under overpressure of 8-10 bar. The synthesis gas was finally fed to the energy conversion unit 142 implemented as a gas-piston power plant, where the chemical energy of the dried and purified synthesis gas was converted into mechanical energy, then into electrical energy and thermal energy.

The gas chromatographic analysis of the synthesis gas obtained by the thermolysis of the waste mixture showed the presence of the following components in the synthesis gas:

| | vol. % | | | | | | | | | | | |
|---|---|---|---|---|---|---|---|---|---|---|---|---|
| Component | | | | | | Ethane | Propane | C4 | C5 | C6 | | Total |
| name | H2 | N2 | CH4 | CO | CO2 | Ethylene | Propylene | sum | sum | sum | H2O | sum |
| 720° C.-760° C. | 38.55 | 12.22 | 16.97 | 20.11 | 6.20 | 2.65 | 0.14 | 0.12 | 0.73 | 0.41 | 1.90 | 100.0 |

The calorific value of the synthesis gas (by combustible fraction): Qn lower = 22.32 MJ/m³.
The density of the synthesis gas: P = 0.96 kg/m³.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A system for conducting high-temperature thermolysis of a waste mixture, comprising:
a sewage sludge storage configured to receive and store sewage sludge;
a wood waste storage configured to receive and store wood waste;
a mixer configured to form the waste mixture by mixing the sewage sludge from the sewage sludge storage and the wood waste from the wood waste storage;
a screw-conveyor dryer configured to heat and dehumidify the waste mixture;
a metering hopper arranged between the mixer and the screw-conveyor dryer, the metering hopper being configured to perform a metered supply of the waste mixture from the mixer to the screw-conveyor dryer while replacing ambient air with carbon dioxide (CO2);
a carbon dioxide (CO2) source coupled to the metering hopper and configured to supply the carbon dioxide (CO2) to the metering hopper;
a striker mill coupled to the screw-conveyor dryer and configured to obtain a pulverized mixture by conducting the high-temperature thermolysis of the waste mixture, the pulverized mixture comprising a solid fraction and a gas-vapor fraction, the solid fraction comprising coarse-grained hard carbon and fine-grained hard carbon;
a first cyclonic separator coupled to the striker mill and configured to separate the coarse-grained hard carbon from the solid fraction of the pulverized mixture;
a first storage configured to receive and store the coarse-grained hard carbon;
a first heat exchanger arranged between the first cyclonic separator and the first storage, the first heat exchanger being configured to cool and transport the coarse-grained hard carbon from the first cyclonic separator to the first storage;
a second cyclonic separator coupled to the first cyclonic separator and configured to separate the fine-grained hard carbon from the solid fraction of the pulverized mixture;
a second storage configured to receive and store the fine-grained hard carbon;
a second heat exchanger arranged between the second cyclonic separator and the second storage, the second heat exchanger being configured to cool and transport the fine-grained hard carbon from the second cyclonic separator to the second storage;
a condenser coupled to the second cyclonic separator and configured to obtain a thermolysis liquid and a synthesis gas by cooling and condensing the gas-vapor fraction of the pulverized mixture;
a thermolysis liquid storage coupled to the condenser and configured to receive and store the thermolysis liquid;
a first synthesis gas storage coupled to the condenser and configured to receive and store the synthesis gas under overpressure of 1 bar;
a second synthesis gas storage configured to receive and store the synthesis gas under overpressure up to 10 bar;
a gas compressor arranged between the first synthesis gas storage and the second synthesis gas storage, the gas compressor being configured to pump over the synthesis gas from the first synthesis gas storage to the second synthesis gas storage while increasing a pressure of the synthesis gas up to 10 bar;
a fine filter coupled to the second synthesis gas storage and configured to purify the synthesis gas from mechanical impurities;
a third synthesis gas storage coupled to the fine filter and configured to receive and store the purified synthesis gas under overpressure up to 10 bar; and
an energy conversion unit coupled to the third synthesis gas storage and configured to convert a chemical energy of the purified synthesis gas into thermal and electrical energy.

2. The system of claim 1, wherein the sewage sludge has a humidity of 8-12% and a fragment size of 5-7 mm.

3. The system of claim 1, wherein the wood waste has a humidity of 10-12% and a fragment size of 3-6 mm.

4. The system of claim 1, wherein the mixer is configured to form the waste mixture such that the sewage sludge and the wood waste are contained in the waste mixture in a proportion of 65 wt % by 35 wt %, respectively.

5. The system of claim 1, wherein the metering hopper comprises:
a screw conveyor having a first end and a second end;
an electric drive coupled to the first end of the screw conveyor, the electric drive being configured to drive the screw conveyor;
a working chamber coupled to the second end of the screw conveyor, the working chamber having an inner cavity;
a charging cone attached to the screw conveyor near the first end of the screw conveyor;
an air outlet nozzle attached to the working chamber;
a carbon dioxide inlet nozzle attached to the screw conveyor near the first end of the screw conveyor; and
an electric sliding gate attached to the working chamber from below, the electric sliding gate being configured to cause the waste mixture to move from the inner cavity to the screw-conveyor dryer.

6. The system of claim 1, wherein the screw-conveyor dryer is configured to dehumidify the waste mixture up to a humidity of 2-3% and heat the waste mixture up to a temperature of 350 to 400° C.

7. The system of claim 1, wherein the screw-conveyor dryer comprises:
a hollow body comprising an inlet nozzle, a top coupling pipe, an outlet nozzle, a bottom tube, a bottom coupling pipe, a middle tube, and a top tube, wherein each of the bottom tube, the middle tube and the top tube having a screw conveyor arranged therein, the inlet nozzle is coupled to a system for supplying a gaseous heat-conducting medium to the hollow body, the outlet nozzle is coupled to a system for removing the gaseous heat-conducting medium from the hollow body, the top coupling pipe is configured to connect the top tube and the middle tube, the bottom coupling pipe is configured to connect the middle tube and the bottom tube, and the middle tube is larger than the top tube in diameter but smaller than the bottom tube in diameter;
a top electric drive coupled to the screw conveyor in the top tube;
a middle electric drive coupled to the screw conveyor in the middle tube;
a bottom electric drive coupled to the screw conveyor in the bottom tube; and
a charging hopper attached to the top tube and configured to receive the waste mixture from the metering hopper.

8. The system of claim 1, wherein the striker mill is configured to conduct the high-temperature thermolysis of the waste mixture at a temperature of 720 to 760° C.

9. The system of claim 1, wherein the striker mill comprises:
a working chamber having a first cavity and a second cavity, the first cavity having a cylindrical part and a toroidal part, the cylindrical part having a bottom, the cylindrical part and the toroidal part being interconnected near the bottom of the cylindrical part to form an annular slot having an upper section and a lower section, the cylindrical part having an inlet pipe coupled to the screw-conveyor dryer and an outlet pipe coupled to the first cyclonic separator, the second cavity surrounding the toroidal part of the first cavity, the second cavity having at least one inlet nozzle for a heat-conducting medium and at least one outlet nozzle for the heat-conducting medium;
a vertical drive shaft having a first end arranged outside the working chamber and a second end arranged inside the cylindrical part of the first cavity;
an electric drive coupled to the first end of the vertical drive shaft; and
a horizontal spreading disk attached to the second end of the vertical drive shaft, the horizontal spreading disk being arranged opposite to and aligned with the annular slot, the horizontal spreading disk being configured, due to a centrifugal force, to feed the waste mixture from the cylindrical part of the first cavity into the toroidal part of the first cavity through the upper section of the annular slot and then to remove the resulting pulverized mixture from the toroidal part of the first cavity through the lower section of the annular slot and the outlet pipe.

10. The system of claim 1, wherein the first cyclonic separator is a uniflow cyclone.

11. The system of claim 1, wherein the second cyclonic separator is a group cyclone.

12. A method for conducting high-temperature thermolysis of a waste mixture, comprising:
forming the waste mixture by mixing sewage sludge and wood waste in a mixer;
by using a metering hopper, performing a metered supply of the waste mixture from the mixer to a screw-conveyor dryer while replacing ambient air with carbon dioxide (CO2);
heating and dehumidifying the waste mixture in the screw-conveyor dryer;
obtaining a pulverized mixture by conducting the high-temperature thermolysis of the heated and dehumidified waste mixture in a striker mill, the pulverized mixture comprising a solid fraction and a gas-vapor fraction, the solid fraction comprising coarse-grained hard carbon and fine-grained hard carbon;
by using a first cyclonic separator, separating the coarse-grained hard carbon from the solid fraction of the pulverized mixture;
by using a first heat exchanger, transporting the separated coarse-grained hard carbon to a first storage;
by using a second cyclonic separator, separating the fine-grained hard carbon from the solid fraction of the pulverized mixture that has passed the first cyclonic separator;
by using a second heat exchanger, transporting the separated fine-grained hard carbon to a second storage;
by using a condenser, obtaining a thermolysis liquid and a synthesis gas by cooling and condensing the gas-vapor fraction of the pulverized mixture that has passed through the first cyclonic separator and the second cyclonic separator;
storing the separated thermolysis liquid in a thermolysis liquid storage;
storing the separated synthesis gas in a first synthesis gas storage under overpressure of 1 bar;
by using a gas compressor, pumping over the synthesis gas from the first synthesis gas storage to a second synthesis gas storage while increasing a pressure of the synthesis gas up to 10 bar;
by using a fine filter, purifying the synthesis gas from the second synthesis gas storage from mechanical impurities;
storing the purified synthesis gas in a third synthesis gas storage under overpressure up to 10 bar; and
by using an energy conversion unit, converting a chemical energy of the purified synthesis gas from the third synthesis gas storage into thermal and electrical energy.

13. The method of claim 12, wherein the sewage sludge has a humidity of 8-12% and a fragment size of 5-7 mm.

14. The method of claim 12, wherein the wood waste has a humidity of 10-12% and a fragment size of 3-6 mm.

15. The method of claim 12, wherein the waste mixture is formed in the mixer such that the sewage sludge and the wood waste are contained in the waste mixture in a proportion of 65 wt % by 35 wt %, respectively.

16. The method of claim 12, wherein the waste mixture is dehumidified up to a humidity of 2-3% and heated up to a temperature of 350 to 400° C. in the screw-conveyor dryer.

17. The method of claim 12, wherein the high-temperature thermolysis of the waste mixture is conducted in the striker mill at a temperature of 720 to 760° C.
